(19) United States
(12) Patent Application Publication
(10) Pub. No.: US 2026/0118731 A1
(43) Pub. Date: Apr. 30, 2026

(54) ELECTRONIC PAPER DISPLAY DEVICE

(71) Applicant: Sharp Display Technology Corporation, Kameyama City (JP)

(72) Inventor: Kira IKEDA, Kameyama City (JP)

(21) Appl. No.: 19/364,088

(22) Filed: Oct. 21, 2025

(30) Foreign Application Priority Data
Oct. 25, 2024 (JP) 2024-188046

(51) Int. Cl. G02F 1/167; G02F 1/16753; G02F 1/1676

(52) U.S. Cl. CPC G02F 1/167; G02F 1/16753; G02F 1/1676

(57) ABSTRACT

An electronic paper display device includes an electronic paper unit configured to electrically rewrite a display image and keep the display image without supply of power and a heating unit disposed in a peripheral edge portion of the electronic paper unit to heat the electronic paper unit.

### CROSS REFERENCE TO RELATED APPLICATION

This application claims priority from Japanese Patent Application No. 2024-188046 filed on October 25, 2024. The entire contents of the priority application are incorporated herein by reference.

### TECHNICAL FIELD

The present technology described herein relates to an electronic paper display device.

### BACKGROUND

An electronic paper is a reflective type display device that performs displaying with using reflected light similar to a paper. There has been an electronic paper that uses electric power only in rewiring information and can keep the displayed image after the supply of power stops. In such an electronic paper, power consumption is much smaller than liquid crystal display devices and organic EL display devices.

It may take a long time for an electronic paper to switch the display image in a low environment temperature.

The technology described herein was made in view of the above circumstances. An object is to provide an electronic paper display device that improves display quality in a low environment temperature.

### SUMMARY

The technology described herein is an electronic paper display device including any combination of the following (1) to (12).

(1) An electronic paper display device includes an electronic paper unit configured to electrically rewrite a display image and keep the display image without supply of power, and a heating unit disposed in a peripheral edge portion of the electronic paper unit and heating the electronic paper unit.

(2) In the electronic paper display device, in addition to (1), heating unit may be disposed outside a display area of the electronic paper unit where the display image is displayed.

(3) The electronic paper display device may further include, in addition to (1) or (2), a support frame that supports the heating unit with respect to the electronic paper unit, and the support frame may include at least one of heat insulation material or heat shielding material.

(4) The electronic paper display device may further include, in addition to any one of (1) to (3), a cover layer that covers a display surface of the electronic paper unit. The heating unit may be configured to heat the electronic paper unit via the cover layer.

(5) The electronic paper display device may further include, in addition to any one of (1) to (4), a control section configured to control driving of the heating unit, and a temperature sensor. The control section may be configured to drive the heating unit if an environment temperature detected by the temperature sensor is a first threshold value or lower, and to stop the driving of the heating unit if the environment temperature detected by the temperature sensor is a second threshold value or higher. The second threshold value may be higher than the first threshold value.

(6) In the electronic paper display device, in addition to any one of (1) to (5), the heating unit may include an infrared light source that emits infrared rays.

(7) In the electronic paper display device, in addition to (6), the infrared light source may include an infrared light emitting diode.

(8) The electronic paper display device may further include, in addition to (6) or (7), a cover layer that covers a display surface of the electronic paper unit. The cover layer may include an infrared reflection layer that reflects the infrared rays and may be disposed away from the display surface of the electronic paper unit via the heating unit.

(9) In the electronic paper display device, in addition to (4) or (8), the cover layer may include a light guide layer in which at least one of white light or the infrared rays travel.

(10) The electronic paper display device may further include, in addition to (9), a white light source that emits the white light. The light guide layer may be configured such that the white light emitted by the white light source travels in light guide layer to the display surface of the electronic paper unit.

(11) The electronic paper display device may further include, in addition to any one of (1) to (10), an infrared light source disposed on a display surface side of the electronic paper unit as the heating unit, a white light source disposed farther from a display surface of the electronic paper unit than the infrared light source is, a first cover layer that covers the display surface and includes an infrared reflection layer reflecting infrared rays emitted by the infrared light source, and a second cover layer that is disposed farther from the display surface than the first cover layer is and covers the display surface and includes a light guide layer in which white light emitted by the white light source travels.

(12) In the electronic paper display device, in addition to anyone of (1) to (11), the electronic paper unit may include a transparent electrode substrate including a transparent electrode, a back electrode substrate including back electrodes corresponding to pixels, the back electrodes including thin film transistors, and a display medium layer disposed between the transparent electrode substrate and the back electrode substrate and including a display medium.

According to the technology described herein, an electronic paper display device that improves display quality in a low environment temperature is provided.

### BRIEF DESCRIPTION OF THE DRAWINGS

FIG. 1 is a plan view schematically illustrating a configuration of an electronic paper display device according to one embodiment.

FIG. 2 is a cross-sectional view along A-A line in FIG. 1.

FIG. 3 is a cross-sectional view along B-B line in FIG. 2.

FIG. 4 is a cross-sectional view schematically illustrating a configuration of the electronic paper display device according to one embodiment.

FIG. 5 is a plan view schematically illustrating a configuration of a back electrode of the electronic paper display device according to one embodiment.

FIG. 6 is a cross-sectional view schematically illustrating a configuration of an electronic paper display device according to another embodiment.

FIG. 7 is a cross-sectional view along C-C line in FIG. 6.

FIG. 8 is a cross-sectional view schematically illustrating a configuration of an electronic paper display device according to another embodiment.

FIG. 9 is a cross-sectional view schematically illustrating a configuration of an electronic paper display device according to another embodiment.

FIG. 10 is a cross-sectional view schematically illustrating a configuration of a portion of an electronic paper display device according to another embodiment.

FIG. 11 is a block diagram illustrating a configuration of a control device of the electronic paper display device according to one embodiment.

FIG. 12 is a block diagram illustrating a configuration of a control device of the electronic paper display device according to another embodiment.

### DETAILED DESCRIPTION

### First Embodiment

An electronic paper display according to a first embodiment will be described with reference to the drawings. The electronic paper display of this embodiment is an electrophoretic display device; however, the present technology is not necessarily limited to such a display device.

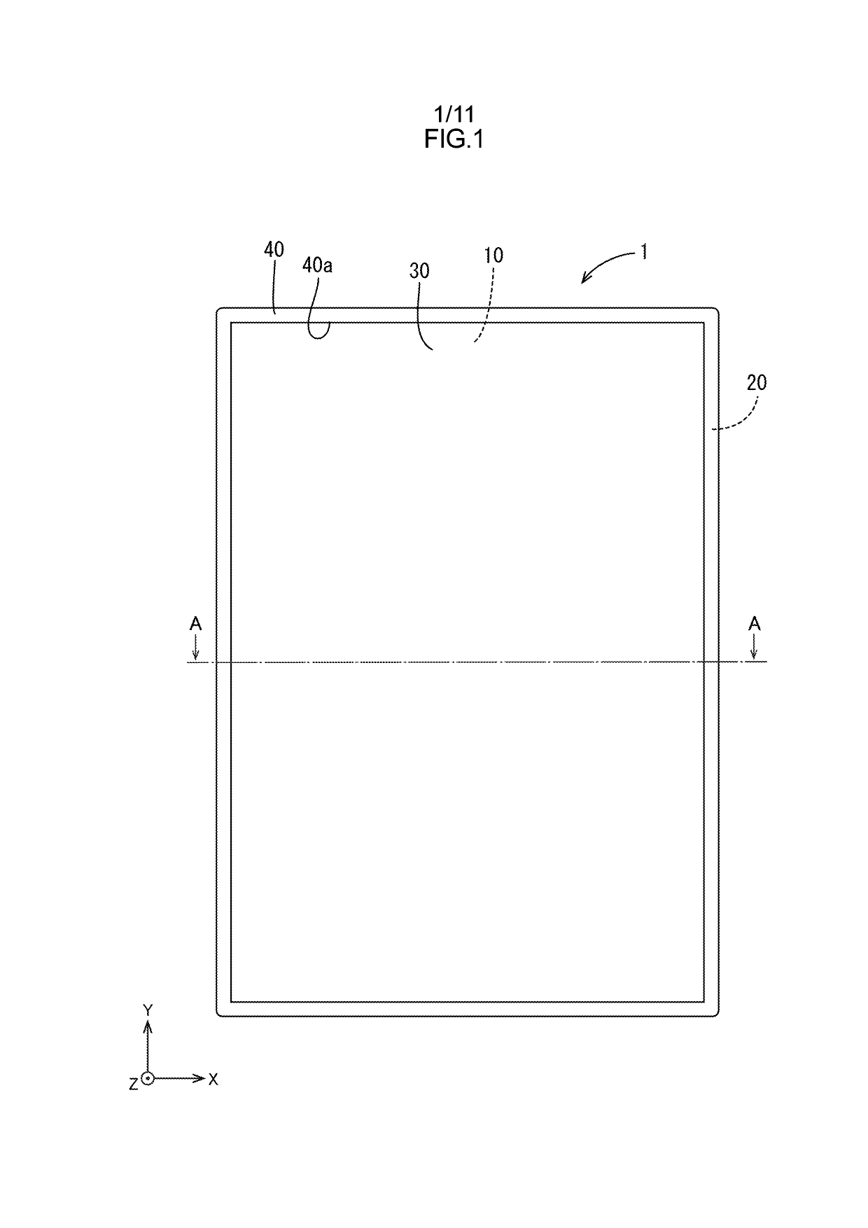

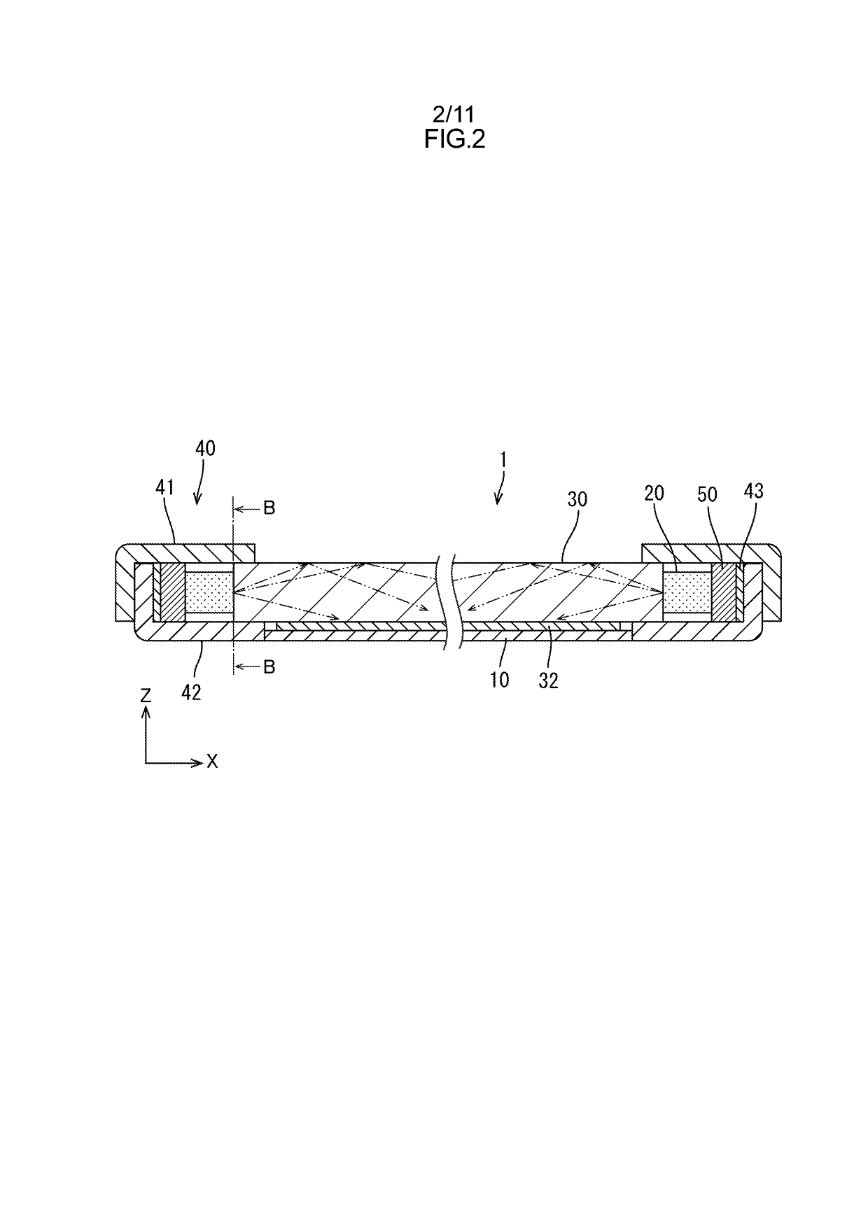

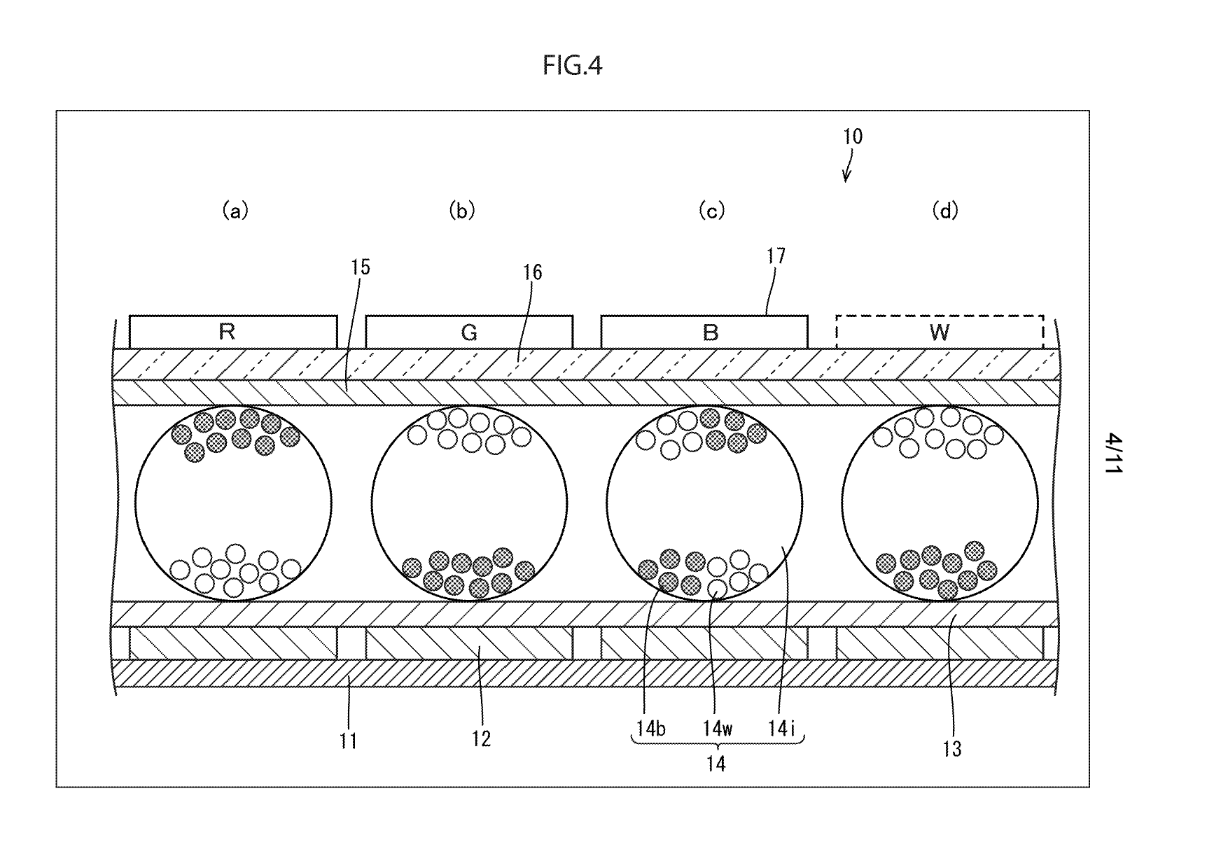

FIG. 1 is a plan view schematically illustrating an electronic paper display device 1 of this embodiment. FIG. 2 is a cross-sectional view along A-A line in FIG. 1 and FIG. 4 is a cross-sectional view along B-B line in FIG. 2. Arrows X, Y, and Z in the drawings represent directions that cross (for instance are perpendicular to each other) and correspond to a short-side direction, a long-side direction, and a thickness direction (namely, a normal direction to a display surface) of the electronic paper display device 1 of a rectangular shape. An upper side and a lower side in FIG. 2 correspond to a display surface side and a back surface side of the electronic paper display device 1, respectively.

The electronic paper display device 1 of this embodiment (may be referred to as the display device 1) can electrically rewrite a displayed image and keep the displayed image without the supply of power. Therefore, the display device 1 does not necessarily include a backlight unit that is usually included in a liquid crystal display device and performs displaying by reflecting external light similar to a paper. Accordingly, compared to a liquid crystal display device, the display device 1 can be reduced in weight, thickness, and power consumption. Further, display with the display device 1 is good for eyes.

As illustrated in FIG. 1, the display device 1 has a rectangular flat plate shape and includes an electronic paper unit 10 displaying an image and a heating unit 20 for heating the electronic paper unit 10. The display device 1 may include a light guide plate 30 (one example of a cover layer) that covers a display surface of the electronic paper unit 10, a frame portion 40 (one example of a support frame) that supports the light guide plate 30 with respect to the electronic paper unit 10, and a control device 50. The display device 1 does not include a backlight unit that allows an image to be seen on the display screen surface.

First, a configuration of the electronic paper unit 10 will be described. The electronic paper unit 10 is configured as a main component of the display device 1 and for displaying a display image based on image information. The electronic paper unit 10 can electrically rewrite a displayed image and keep the displayed image without being supplied with power. The electronic paper unit 10 of this embodiment has a rectangular flat plate shape as a whole and has a display surface displaying an image on an upper side in FIG. 2 and a back surface on a lower side.

FIG. 4 is a cross-sectional view schematically illustrating a configuration of the electronic paper unit 10 of this embodiment. The electronic paper unit 10 typically includes microcapsules 14 that are arranged in a single layer between two transparent films 13, 15, a back electrode 12 disposed on a back surface side of the microcapsules 14, and a transparent electrode 16 disposed on a front surface side of the microcapsules 14. A single layer of the microcapsules 14 may be defined as an electronic ink layer. The electronic ink layer is one example of a display medium layer of the present technology and the microcapsules 14 are one example of a display medium. The back electrode 12 is supported by a base member 11. The transparent electrode 16 is disposed on a front surface side of the film 15. The components of the electronic paper unit 10 and the arrangement of the components are not limited to those described herein.

Each pixel of the electronic paper unit 10 includes four sub-pixels of red (R), green (G), blue (B), and white (W). In areas corresponding to the red (R), green (G), and blue (B) sub-pixels, color filters 17 corresponding to the respective colors are disposed on the front surface side of the transparent electrode 16. In the area corresponding to the white (W) sub-pixel, no color filter is disposed.

Each of the microcapsules 14 includes black particles 14b and white particles 14w, which can be electrically operated, and transparent insulating liquid 14i. For instance, the black particles 14b are negatively charged carbon particles and the white particles 14w are positively charged titanium oxide particles, and the insulating liquid 14i is silicone oil. The black particles 14b and the white particles 14w are dispersed in the insulating liquid 14i.

As illustrated in the area (a) in FIG. 4, with a negative electric field relative to the transparent electrode 16 being applied to the back electrode 12, which is a back surface side of the microcapsule 14, the negatively charged black particles 14b move to the front surface side of the microcapsule 14 due to a repulsion force. The positively charged white particles 14w move to the back surface side of the microcapsule 14 due to an attraction force. Accordingly, the microcapsule 14 exhibits black on the front surface side under white light (sun light, for instance). The microcapsule 14 exhibiting black does not reflect light. Therefore, even with the color filter 17 being disposed, the color of the color filter 17 is not displayed but black is exhibited in the portion of the display surface corresponding to the microcapsule 14 exhibiting black.

On the other hand, as illustrated in the areas (b) and (d) in FIG. 4, with a positive electric field relative to the transparent electrode 16 being applied to the back electrode 12, the negatively charged black particles 14b move to the back surface side of the microcapsules 14 due to an attraction force and the positively charged white particles 14w move to the front surface side of the microcapsules 14 due to a repulsion force. Accordingly, the microcapsules 14 exhibits white on the front surface side under white light (sun light, for instance). The microcapsules 14 exhibiting white reflects light. Therefore, in the portions of the display surface corresponding to the microcapsules 14 exhibiting white, for instance, white is exhibited in the area (d) corresponding to the sub-pixel (W) including no color filter 17 and the color of the color filter 17 (red, green, or blue), which is green (G) in the area (b), is exhibited.

As illustrated in the area (c) in FIG. 4, with no electric filed being applied or a negative electric filed being applied to a portion of the microcapsule 14 on the back surface side and a positive electric field being applied to another portion of the microcapsule 14, both of the black particles 14b and the white particles 14w are on the front surface side and on the back surface side of the microcapsule 14. Accordingly, gray is exhibited in the area (c). With the microcapsules 14 (sixteen microcapsules 14, for instance) being arranged for each pixel or each sub-pixel and the exhibiting color being controlled, gray scale display of multiple gradation (sixteen gradation, for instance) can be performed. With combining the gray scale display of multiple gradation and color display with color filters, full color display of 4,096 colors, for instance, can be performed.

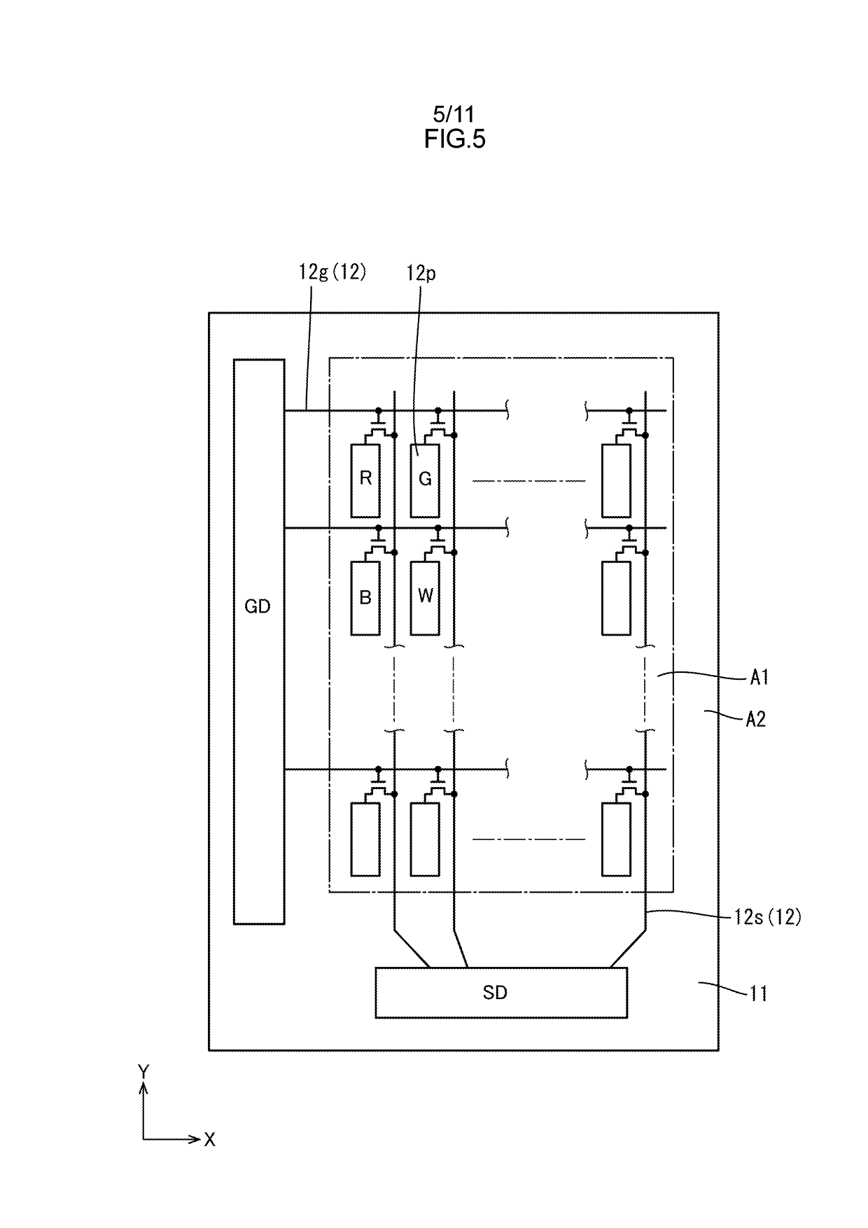

FIG. 5 is a plan view schematically illustrating the back electrode 12 of the electronic paper display device 1. The base member 11 and the back electrode 12 have a similar configuration as that of the active matrix substrate included in a liquid crystal display device. The base member 11 includes a display area A1 in which an image is displayed and a non-display area A2 in which no image is displayed. The display area A1 is seen through an opening 40a of the frame portion 40 (refer to FIG. 1) and the non-display area A2 is covered by the frame portion 40. The back electrode 12 is disposed on a surface of the base member 11 that faces the transparent electrode 16. The back electrode 12 includes gate lines 12g that extend along the short-side direction X and source lines 12s that extend along the long-side direction Y. The base member 11 includes pixel areas that are defined by the gate lines 12g and the source lines 12s. In this embodiment, each of the pixel areas corresponds to the sub-pixel. The display area A1 includes the pixel areas that are arranged in rows and columns.

A surrounding circuit is disposed in the non-display area A2. A gate driver GD that drives the gate lines 12g is monolithically fabricated on the base member 11 as the surrounding circuit. A source driver SD that drives the source lines 12s is mounted on the base member 11. An SSD (source shared driving) circuit that drives a source bus line (the source lines 12s) with a time-sharing method may be disposed as the surrounding circuit. The SSD circuit may be monolithically fabricated on the base member 11 similar to the gate driver GD.

In each of the pixel areas, a switching component (such as a thin film transistor: TFT) is disposed and a gate electrode of the TFT is connected to the gate line 12g, a source electrode of the TFT is connected to the source line 12s, and a drain electrode of the TFT is connected to the transparent pixel electrode 12p. The gate lines 12g are connected to the gate driver GD in the non-display area A2. Driving of the TFT is controlled according to a scan signal that is input to the gate electrode from the gate driver. The source lines 12s are connected to the source driver SD in the non-display area A2. When the TFT is driven (ON), the pixel electrode 12p is charged based on a voltage (a data signal) corresponding to a display level inputted to the source line 12s from the source driver SD. An electric field is applied to the microcapsules 14 (the electronic ink layer) and the electric filed is changed by controlling the pixel electrode 12p and the opposed transparent electrode 16. The display device 1 is configured to display a predefined display image with predefined image signals being supplied to the lines of the electronic paper unit 10 (for instance, scan signals are supplied to the gate lines and data signals are supplied to the source lines). The TFT may be an a-Si TFT that includes a channel section made of amorphous silicon or an organic TFT that includes a channel section made of organic semiconductor material such as polyfluorene.

The heating unit 20 is a component for heating the electronic paper unit 10. The heating unit 20 heats the electronic paper unit 10 to be within a predefined temperature range (for instance, from 0°C to 50°C) such that display switching of the electronic paper unit 10 can be performed with an appropriate time. The heating unit 20 heats the electronic paper unit 10 with thermal conduction, convective heat transfer, radiant heat transfer, or a combination thereof. The heating unit 20 is configured to heat the electronic paper unit 10 with or without being contact with the electronic paper unit 10. The heating unit 20 is preferably configured to heat the electronic paper unit 10 without contact. The heating unit 20 may include a heat source that can perform heating based on electric energy. The heating unit 20 may include a light radiant heat source that can heat with light.

The heating unit 20 is arranged in a peripheral edge portion of the electronic paper unit 10. In the electronic paper unit 10, the heating unit 20 is disposed outside the display area A1 where a display image is displayed. The heating unit 20 is disposed outside the electronic paper unit 10 with respect to a direction along an X-Y surface that corresponds to the display surface of the electronic paper unit 10. Namely, the heating unit 20 is disposed not to overlap the electronic paper unit 10. In this embodiment, the heating unit 20 is disposed outside the display area A1 with respect to the X-Y surface and outside (an outer peripheral edge of) the light guide plate 30.

The light radiant heat source is a heat source using infrared radiation and may be a flush lamp, an LED (light emitting diode), and a halogen lamp that can emit infrared rays or near infrared rays. The heating unit 20 of this embodiment includes an infrared emitting diode (hereinafter, referred to as an infrared LED) as a heat source. The heating unit 20 includes infrared LEDs of a point light source.

The single infrared LED is a point light source. The infrared LEDs of this embodiment are light emitting diodes that emit near infrared having a wavelength ranging from about 700 nm to 2000 nm (for instance, 740 nm, 850 nm, 940 nm, 1050 nm, 1300 nm). The infrared LEDs of this embodiment emit light that is not visible for human beings. The infrared LEDs that are suitable for surface mounting on the base member such as cannonball type LEDs, top view type LEDs, side view type LEDs, surface mounting type LEDs, chip scale package (CSP) type LEDs, and flip chip mounting type LEDs are preferably used. In this embodiment, top view type mini-LEDs are used as the infrared LEDs. The top view type mini-LEDs have a shape of a cuboid having a maximum dimension of 5 mm or smaller.

The heating unit 20 may be configured to supply infrared rays directly to the electronic paper unit 10 or may be configured to supply infrared rays to the electronic paper unit 10 via infrared transfer means. In this embodiment, the heating unit 20 supplies infrared rays to the electronic paper unit 10 via the light guide plate 30, which is infrared transfer means, to heat the electronic paper unit 10.

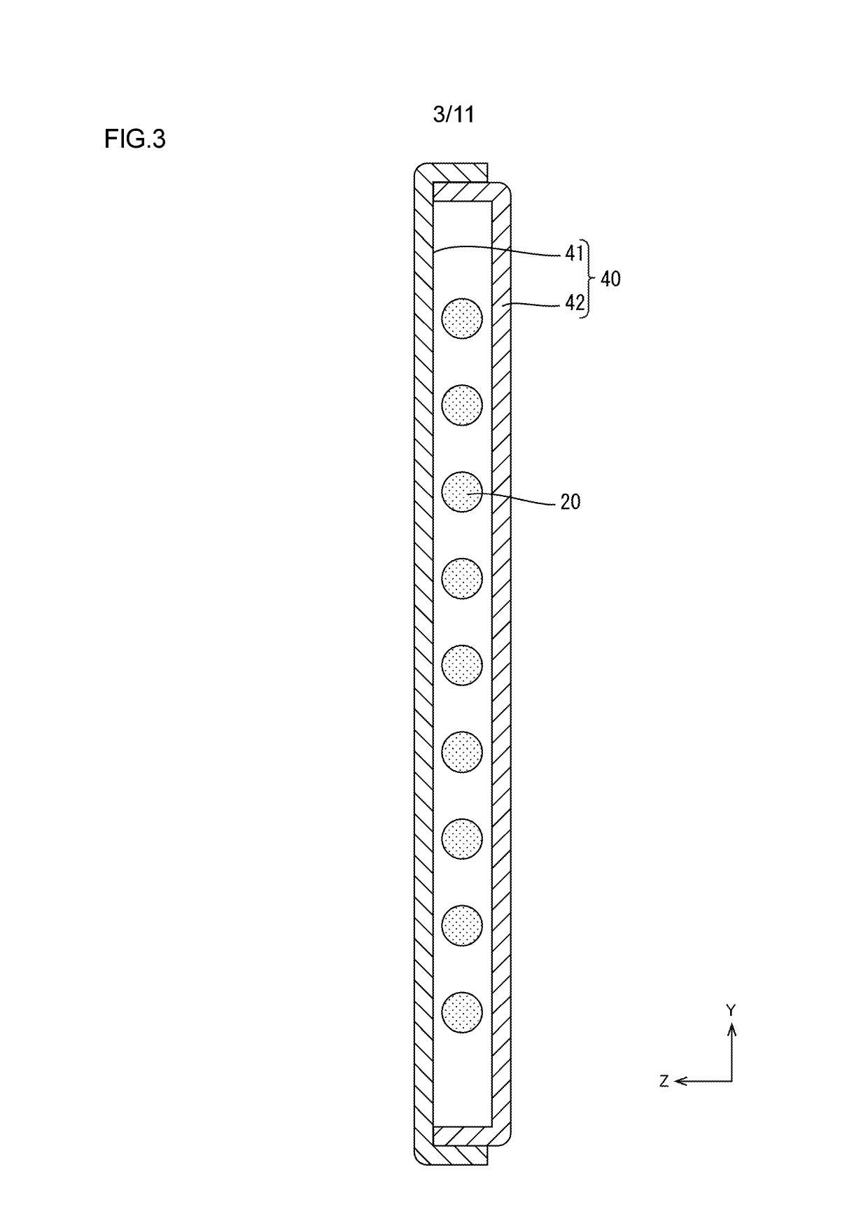

As illustrated in FIG. 2, the heating unit 20 is disposed to face an edge surface of the light guide plate 30 (for instance, a long side edge surface) and configured to supply infrared rays to the edge surface of the light guide plate 30. As illustrated in FIG. 3, in the heating unit 20, the infrared LEDs are arranged at equal intervals along the edge surface of the light guide plate 30. Accordingly, the display surface (eventually the electronic ink layer) of the electronic paper unit 10 can be heated uniformly. The heating unit 20 of this embodiment is configured to be operated when a main power of the display device 1 is turned on. Therefore, the output of heat from the heat source of the heating unit 20 (for instance, the output of the infrared LED and the number of infrared LEDs) can be changed with considering average heat radiation and heat balance of the display device 1 and the external environment. For instance, by changing the output of the heat source, the temperature of the electronic paper unit 10 may be maintained within a certain range or the time necessary for switching display may be set within a certain range.

The light guide plate 30 is a flat plate or a sheet and infrared rays travel within the light guide plate 30. The light guide plate 30 of this embodiment is a rectangular flat plate that is slightly larger than the electronic paper unit 10 with respect to the X-axis direction and the Y-axis direction with a plan view from the Z-axis direction.

In this embodiment, as illustrated in FIG. 2, the light guide plate 30 is fixed to the electronic paper unit 10. In this embodiment, the light guide plate 30 and the electronic paper unit 10 are configured as a unitary component with optically clear adhesive (OCA) 32 that is disposed on the non-display area A2 of the electronic paper unit 10. The light guide plate 30 is disposed to cover the electronic paper unit 10 with respect to the X-axis direction and the Y-axis direction and is one example of a cover layer of the present technology.

The long side edge surface of the light guide plate 30 faces the heating unit 20 and is a light entrance surface through which infrared rays emitted by the heating unit 20 enters. The light guide plate 30 is configured to receive the infrared rays emitted by the infrared LEDs, which are point light sources, and output uniform planar infrared rays toward the electronic paper unit 10. For instance, the infrared rays entering through the light entrance surface of the light guide plate 30 along the X-axis direction travel within the light guide plate 30 and then the infrared rays are directed toward the electronic paper unit 10 and exit through an exit surface (a back surface) of the light guide plate 30 that faces the electronic paper unit 10.

The light guide plate 30 has a refractive index that is sufficiently higher than that of air (for instance, the refractive index is higher than 1, typically 1.1 or higher, for instance 1.2 or higher, and 1.4 or higher) and is made of transparent synthetic resin material or glass having a high refractive index with respect to the light rays emitted by the infrared LED (typically, visible light and infrared rays). Examples of the transparent synthetic resin material include acrylic resin such as PMMA, silicone resin, polyethylene terephthalate (PET), polycarbonate (PC), polystyrene, and urethane resin. In this embodiment, the light guide plate 30 is made of transparent glass. The surface (the back surface) of the light guide plate 30 that faces the electronic paper unit 10 may be embossed such that infrared rays uniformly exit toward the electronic paper unit 10. Recesses and protrusions may be formed by processing the light guide plate 30 or protrusions may be formed (with printing or transferring) on the light guide plate 30. The light guide plate 30 of this embodiment is not warped at a normal temperature but may have flexibility at a normal temperature.

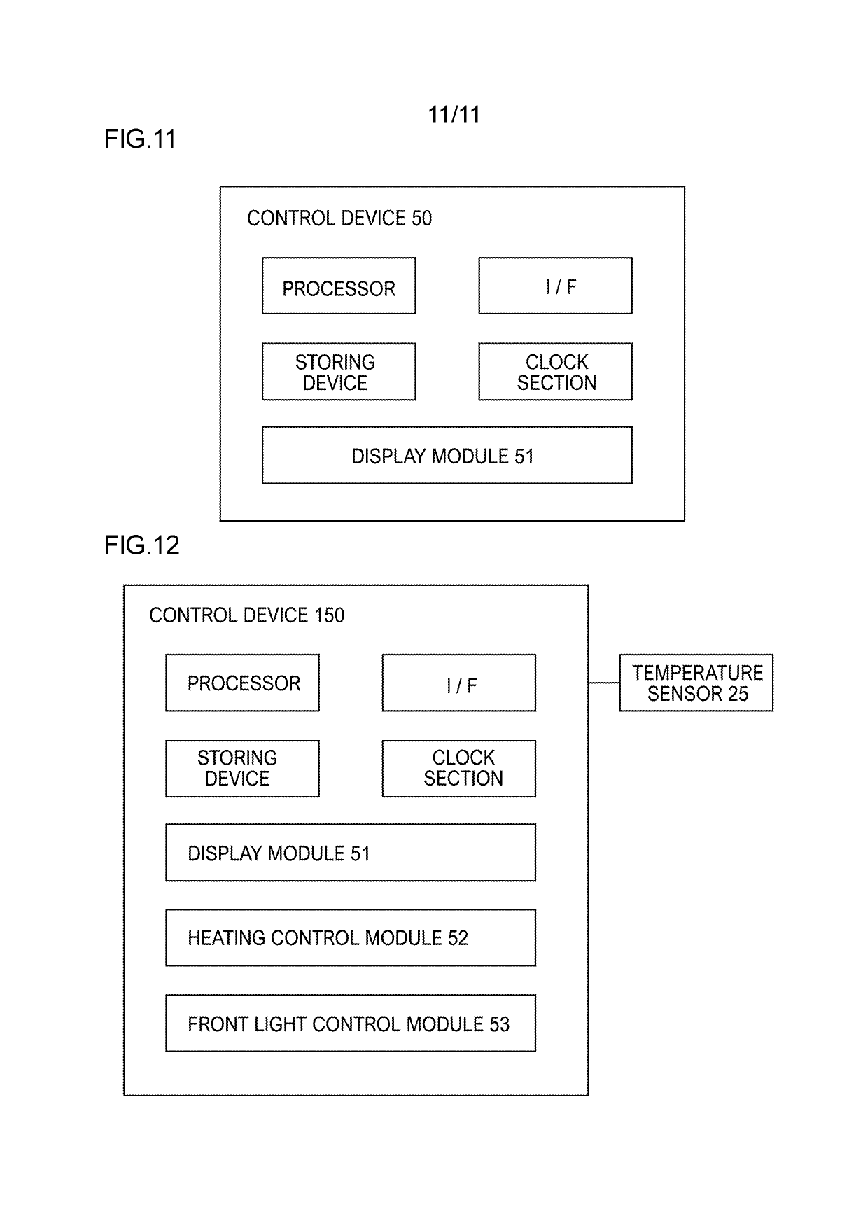

The control device 50 is configured to control operations of the display device 1. FIG. 11 is a block diagram illustrating a configuration of the control device 50 of the electronic paper display device. The control device 50 includes a processor such as a central processing unit (CPU) that performs digital signal processing and various programs, a storing device (a memory) such as a read only memory (ROM) storing the programs that are performed by the CPU and a random access memory (RAM) used as a working area for loading the program, an input/output section (IF) via which various kinds of signals are transferred with external devices, and a clock section including an oscillation circuit. For instance, a microcomputer is included in the control device 50 of this embodiment. The control device 50 is mounted on an insulating substrate or printed circuit substrate. The control device 50 in each drawing includes a microcomputer that is mounted on the substrate.

The control device 50 further includes a display module 51 that is configured to control display of the electronic paper unit 10. The display module 51 may be a hardware such as a circuit or may be configured to perform operations in response to the execution of a software such as a program stored in the memory by the processor or may be a combination thereof. The display module 51 outputs image display information including gate signals and source signals to the electronic paper unit 10 to display a predefined image and rewrite images.

The frame portion 40 is for supporting the heating unit 20 with respect to the electronic paper unit 10. The frame portion 40 may be further configured to support the electronic paper unit 10, the light guide plate 30, and the control device 50. As illustrated in FIG. 1, the frame portion 40 of this embodiment has a rectangular frame plan view shape and has the opening 40a through which the display area can be seen. As illustrated in FIG. 2, the frame portion 40 has a U-shaped cross section that opens toward a center. The frame portion 40 includes a display surface side frame portion 41 and a back surface side frame portion 42. The display surface side frame portion 41 and the back surface side frame portion 42 are fitted together and integrally formed as the frame portion 40. Other components can be arranged in a space between the display surface side frame portion 41 and the back surface side frame portion 42 of the frame portion 40.

The back surface side frame portion 42 has a flat rectangular box shape (shallow plate shape) that opens upward. The back surface side frame portion 42 includes a bottom surface portion extending along the X-axis direction and the Y-axis direction and a side surface portion extending to surround an entire periphery of the bottom surface portion. The back surface side frame portion 42 has an opening in the bottom surface portion corresponding to an outline of the electronic paper unit 10. The electronic paper unit 10 that is fixed to the light guide plate 30 is fitted in the opening of the bottom surface portion. The peripheral portion of the light guide plate 30 is supported on the bottom surface portion of the back surface side frame portion 42.

The control device 50 is fixed to an edge portion formed by the long-side side surface portion and the bottom surface portion of the back surface side frame portion 42. The control device 50 is supported by the bottom surface portion and fixed to the side surface portion with a fixing member 43 (for instance, a double-sided tape). The heating unit 20 is on the control device 50. The infrared LEDs of the heating unit 20 are configured to emit infrared rays in the X-axis direction (namely, a vertical direction with respect to a substrate on which the infrared LEDs are mounted). The position of the heating unit 20 with respect to the Z-axis direction is adjusted to supply infrared rays to a middle portion of the light guide plate 30 in a thickness direction. A spacer or a support member may be disposed on the back surface side frame portion 42 and the heating unit 20 may be supported by the spacer or the support member from the lower side to adjust the position of the heating unit 20 in the upper-bottom direction.

The display surface side frame portion 41 has a flat rectangular box shape (shallow plate shape) that opens downward. The display surface side frame portion 41 includes an upper surface portion extending along the X-axis direction and the Y-axis direction and a side surface portion extending downward from a peripheral edge of the upper surface portion and extending to surround an entire periphery of the upper surface portion. The display surface side frame portion 41 has an opening that is slightly smaller than an outline of the light guide plate 30. The display surface side frame portion 41 supports the peripheral portion of the light guide plate 30 from above when being fitted to the back surface side frame portion 42 to cover the opening of the back surface side frame portion 42 that opens upward. The opening of the upper surface portion of the display surface side frame portion 41 is larger than the display area of the electronic paper unit 10 with respect to the X-axis direction and the Y-axis direction. Therefore, the display area of the electronic paper unit 10 can be seen from above with a wide viewing angle.

The frame portion 40 may be made of resin material or metal material. The frame portion 40 may include at least one of heat insulation material and heat shielding material such that the electronic paper unit 10 can be heated effectively with heat generated by the heating unit 20. In the present technology, heat insulation material and heat shielding material are material that is less likely to transfer heat. The heat insulation material and the heat shielding material may not be strictly specified but may have thermal conductivity of 100 W/(m·K) or lower at 25°C. For instance, the thermal conductivity of the material is preferably 10 W/(m·K) or lower, 1 W/(m·K) or lower, 0.5 W/(m·K) or lower, 0.2 W/(m·K) or lower, 0.1 W/(m·K) or lower, 0.05 W/(m·K) or lower, 0.04 W/(m·K) or lower, 0.03 W/(m·K) or lower, 0.02 W/(m·K) or lower. Examples of the heat insulation material and the heat shielding material include aluminum heat shielding material having high light reflectance, foamed plastic material including air therein, glass wool, and combinations thereof. In this embodiment, heat insulation material of polyethylene foam having thermal conductivity of 0.05 W/(m·K) or lower is disposed on the inner surface side of the display surface side frame portion 41 and the back surface side frame portion 42.

In the electronic paper display device 1 having such a configuration, with the infrared LEDs of the heating unit 20 emitting infrared rays, the infrared rays travel through the light guide plate 30 and reach the electronic paper unit 10. The electronic paper unit 10 absorbs the infrared rays and is effectively heated. In the electronic paper unit 10, the switching speed of switching image display in the electronic ink layer tends to be decreased in a low environment temperature. Therefore, with the electronic paper unit 10 being in the environment temperature in which the display switching speed is decreased, the electronic paper unit 10 can be heated by the heating unit 20. Accordingly, the delay of switching image display can be suppressed or cancelled.

In the electronic paper display device 1 of this embodiment, the heating unit 20 is disposed outside the display area A1 of the electronic paper unit 10. According to such a configuration, a heating mechanism is not disposed in the display area A1 of the electronic paper unit 10. Therefore, the electronic paper unit 10 can be heated without deteriorating visibility and display quality of the display area A1. Furthermore, the heating unit 20 can be arranged with keeping relatively small thickness of the whole display device 1.

In the electronic paper display device 1 of this embodiment, the heating unit 20 includes an infrared light source that generates infrared rays. With the infrared light source being used as the heat source, the input energy to be supplied to the heating unit 20 (for instance, electric energy) can be converted to heat energy efficiently. The infrared light source includes an infrared light emitting diode. A light and small light source can be used as the infrared light source and therefore, the electronic paper display device 1 that is small and light can be obtained.

The electronic paper display device 1 of this embodiment includes the frame portion 40 (a support frame) that supports the heating unit 20 with respect to the electronic paper unit 10. The frame portion 40 includes a heat insulating layer made of polyethylene foam, for instance. According to such a configuration, heat generated inside the frame portion 40 is less likely to be released to the outside and the electronic paper unit 10 is effectively heated.

The electronic paper display device 1 of this embodiment includes the light guide plate 30 (the cover layer) that covers the display surface of the electronic paper unit 10. The heating unit 20 is configured to heat the electronic paper unit 10 via the light guide plate 30. With the combination of the heating unit 20 and the light guide plate 30, heating energy obtained from the heat source having small carbon footprint can be supplied uniformly to the electronic paper unit 10 with high efficiency. Accordingly, display switching speed is less likely to be decreased in the low temperature environment without increasing excessively the size of the display device 1.

In the electronic paper display device 1 of this embodiment, the electronic paper unit 10 includes the transparent film 15 (an electrode substrate) that includes the transparent electrode 16, the film 13 (a back surface electrode substrate) that includes the back electrodes 12 corresponding to the pixels, and the microcapsules 14 (a display medium layer) that is disposed between the films 13, 15. The back electrodes 12 include the TFTs. According to such a configuration, the electronic paper unit 10 can display images with the active matrix method and images can be displayed with high precision.

The electronic paper unit 10 of the first embodiment is an electrophoretic display device and a voltage is applied to the microcapsules 14 to move the charged particles in the microcapsules 14. However, the display method of the electronic paper unit 10 may not be necessarily the electrophoretic display method and the electronic paper unit 10 may perform display with the following methods.

In the Microcup display, which is one kind of the electrophoretic display, charged white particles, particles or liquid colored with yellow (Y), magenta (M), and cyan (C) (except for black) are enclosed in the microcup (microcapsule) disposed on the resin substrate instead of the monochronic particles. Selected colored particles are collected on the display surface side by changing the electric filed to display an image. In one embodiment with the Microcup display, white particles and yellow particles that are negatively charged and red particles and blue particles that are positively charged and transparent insulating liquid are enclosed in the microcup. By adjusting the size, the amount of charge, and the application of a voltage of each particle of white, red, yellow, and blue, the movement of the particles can be controlled for each color. Accordingly, with six primary colors of red, green, blue, yellow, white, black in each sub pixel, the full-color display with high resolution can be achieved without using the color filters.

In the twist ball type display, a micro ball is colored with two colors in two hemispheres with a charge density difference. The micro ball is rotated by changing the electric filed and a bi-color image is displayed.

In the electronic liquid powder display, charged particles are enclosed in a space and the particles of the selected color are collected to the display surface side by changing the electric field and an image is displayed.

In the electro wetting display, an electrode whose surface is covered with hydrophobic compound is enclosed in the cell with water and colored oil. Wettability of the surface of the electrode is changed by the application of a voltage and the shape of an oil film on the surface of the electrode is adjusted to display an image.

In the cholesteric liquid crystal display, cholesteric liquid crystal material having a twisted pitch of short wavelength level of visible light is used and light of a specified color is reflected by changing the electric field to display an image.

In the micro-electromechanical system display, micro-electromechanical systems (MEMS) having a three-dimensional structure of a micrometer size of the micro processing technology are used and reflected light is converted into light of a predefined color by the light interference caused in an air gap between the films to display an image.

In the display device, the display switching time (rewriting time) necessary for switching the display image may be changed greatly according to the configuration of the electronic paper unit 10 (particularly, the electronic ink layer). For instance, in the display device that performs multi-color display without using the color filters (for instance, the Microcup display), longer display switching time is necessary compared to a display device using the color filters. In such a display device, the display switching time is likely to be longer when the environment temperature is low. In the Microcup display device, it takes about 20 seconds to switch a display image at a normal temperature (25°C) and it takes about 30 seconds to switch a display image in a low temperature environment (5°C). With the configuration of the present technology being applied to such a Microcup display, the display image switching time in the low temperature environment (5°C) is about 20 seconds that is same as the display switching time at a normal temperature. The electronic paper unit 10 can be kept to have the temperature in which the display switching time is shortest according to the configuration of the electronic paper unit 10. With the present technology being applied to a display device in which the display image switching time at the normal temperature (25°C) is one second or more, for instance, ten seconds or more, and particularly, twenty seconds or more, obvious effects can be obtained.

### Second Embodiment

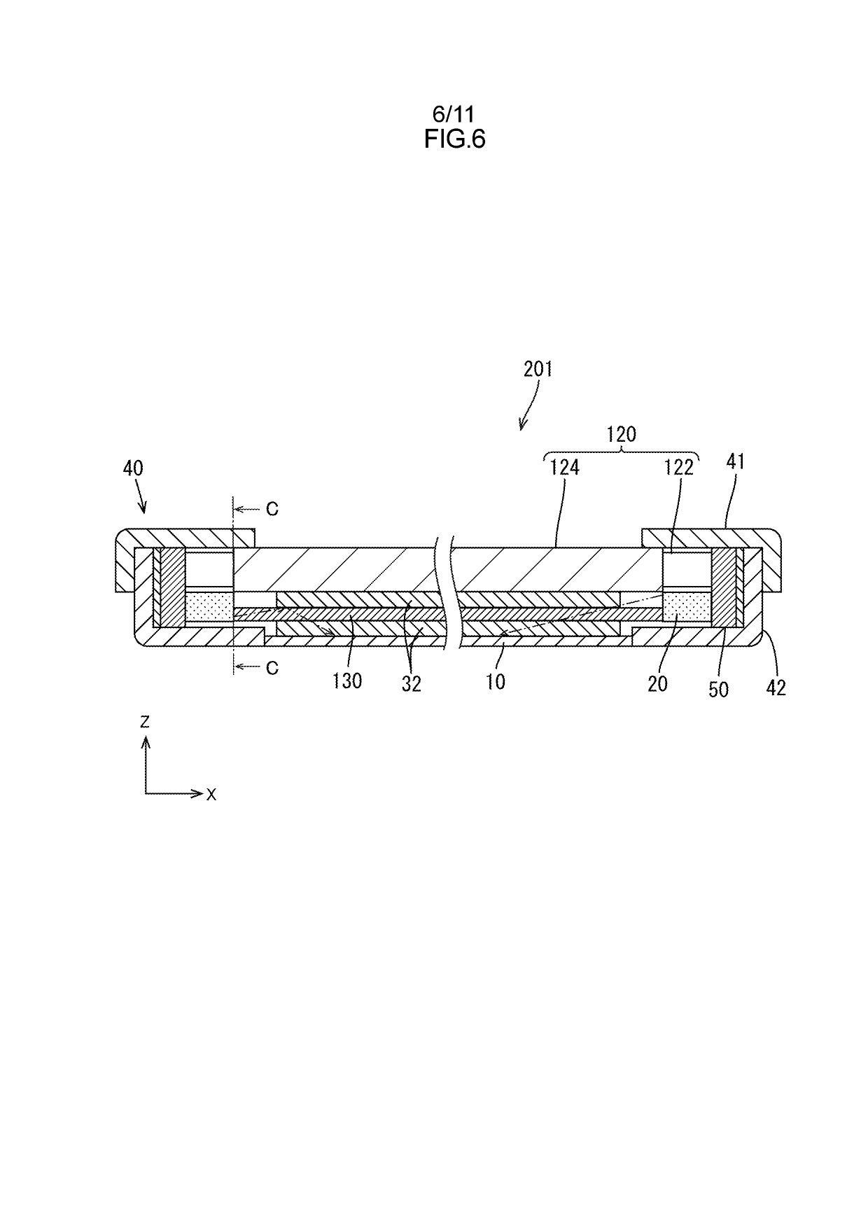

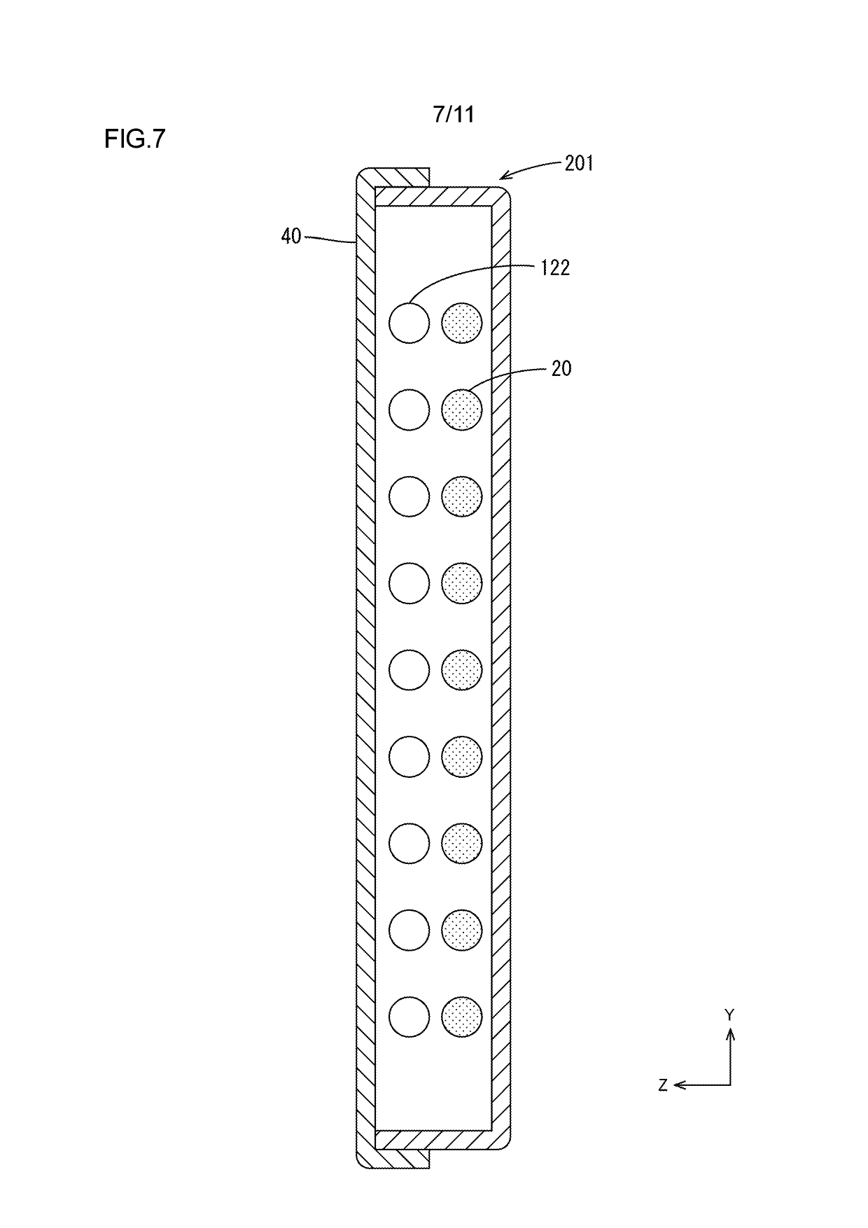

An electronic paper display device 201 of a second embodiment will be described. FIG. 6 is a cross-sectional view schematically illustrating a configuration of the electronic paper display device 201. FIG. 7 is a cross-sectional view along C-C line in FIG. 6. The display device 201 of the second embodiment includes an infrared reflection film 130 instead of the light guide plate 30 of the first embodiment and a front light unit 120. In the display device 201 of the second embodiment, the operation of the heating unit 20 can be controlled. Other configurations of the second embodiment may be similar to those of the first embodiment and configurations, operations, and effects similar to those of the first embodiment may not be described.

This embodiment further includes a temperature sensor 25. The temperature sensor 25 is disposed on the base member where a control device 150 is disposed and electrically connected to the control device 150.

The front light unit 120 will be described. The front light unit 120 is for lighting the display surface of the electronic paper unit 10. The electronic paper unit 10 is a reflective type display device. Therefore, in a dark environment with little external light, with the front light unit 120 supplying light to the display surface, visibility of the display surface is improved. The front light unit 120 includes a white light source 122, a light guide plate 124, and an illuminance sensor.

The white light source 122 is a component that can emit light of a visible light range with a wide wavelength range. Examples of the white light source 122 include a halogen lamp, a fluorescent lamp, an incandescent lamp, and a light emitting diode that emits white light as a whole (hereinafter, referred to as a white LED). The front light unit 120 of this embodiment includes a white LED as the white light source 122. The white LED may include a red LED, a green LED, and a blue LED or may include an ultraviolet LED or a violet LED and red, green, blue phosphors or may include a blue LED and a yellow phosphor or may emit white light by laser excitation or may have other configuration. The front light unit 120 includes point light source type white LEDs.

The light guide plate 124 has a flat plate shape or a sheet form and white light travels within the light guide plate 124. The light guide plate 124 is a light guide layer in which white light travels and one example of a second cover layer of the present technology. The light guide plate 124 has a configuration same as that of the light guide plate 30 of the first embodiment and is made of transparent glass. The surface (back surface) of the light guide plate 124 that faces the electronic paper unit 10 may be embossed such that white light uniformly exits toward the electronic paper unit 10. Recesses and protrusions may be formed by processing the light guide plate 124 or protrusions may be formed (with printing or transferring) on the light guide plate 124. The light guide plate 124 of this embodiment is not warped at a normal temperature but may have flexibility at a normal temperature.

The illuminance sensor is for detecting brightness of the surroundings. For instance, a photodiode or a phototransistor that converts light received by the sensor to a current and outputs a current corresponding to the illuminance or a photoresistor that changes electric resistance according to the intensity of light received by the sensor may be used as the illuminance sensor. The illuminance sensor is disposed on the display surface side frame portion 41 of the frame portion 40 to be exposed to external light (for instance, in a hole) and is electrically connected to the control device 150.

The infrared reflection film 130 reflects infrared rays generated by the heating unit 20. As the infrared reflection film 130, an infrared reflection film having high light transmissive properties in the visible light range (for instance, the visible light transmittance of 70% or higher and preferably 90% or higher) and having high reflectivity in the infrared range may be used. The infrared reflection film may include a film substrate and a multilayered film of metal thin films such as aluminum, iron, stainless, and gold disposed on the back surface side of the film substrate (that faces the electronic paper unit 10) such that the visible light transmittance is at least 70%. With such an infrared reflection film, as illustrated with arrows in FIG. 6, infrared rays supplied from the display surface side are absorbed or pass through to the back surface side and infrared rays supplied from the back surface side pass through to the back surface side.

The infrared reflection film 130 is slightly larger in size than the electronic paper unit 10 with respect to the X-axis direction and the Y-axis direction. The infrared reflection film 130 and the electronic paper unit 10 are configured as a unitary component with optically clear adhesive (OCA) 32 that is disposed on the non-display area A2 of the electronic paper unit 10. The infrared reflection film 130 covers the electronic paper unit 10. The infrared reflection film 130 is fixed to the light guide plate 124 with the OCA 32 that is disposed on the non-display area A2. The surface of the infrared reflection film 130 that is opposite from the surface facing the electronic paper unit 10 is fixed to the light guide plate 124. A distance between the electronic paper unit 10 and the infrared reflection film 130 and a distance between the infrared reflection film 130 and the light guide plate 124 may be adjusted to a certain dimension (for instance, several micrometers to several hundreds of micrometers) for an air layer, which will be described later, with a spacer.

The heating unit 20 and the white light sources 122 of the front light unit 120 are disposed on the control device 150 that is fixed to the back surface side frame portion 42 of the frame portion 40. A row of the infrared LEDs included in the heating unit 20 and a row of the white light sources 122 are arranged in the Z-axis direction and the row of the infrared LEDs included in the heating unit 20 is on a lower side and the row of the white light sources 122 is on an upper side. As illustrated in FIG. 7, in the frame portion 40, the white LEDs are in an upper row (relatively far from the electronic paper unit 10) and the infrared LEDs are in a lower row (relatively close to the electronic paper unit 10). The white LEDs are arranged at equal intervals and the infrared LEDs are arranged at equal intervals.

The electronic paper unit 10 is fitted in the opening of the bottom surface portion of the back surface side frame portion 42. The infrared reflection film 130 is supported on (or fixed to) a peripheral opening edge portion of the opening of the bottom surface portion of the back surface side frame portion 42. The position of the white light sources 122 is adjusted with respect to the Z-axis direction such that white light is supplied to a middle portion of the light guide plate 124 in a thickness direction. The spacer and the support member may be included in the display surface side frame portion 41 or the back surface side frame portion 42 to support the light guide plate 124. Thus, the light guide plate 124 may be stably positioned with respect to the white light sources 122.

FIG. 12 is a block diagram illustrating a configuration of the control device 150 of the electronic paper display device 201. As illustrated in FIG. 12, the control device 150 includes the display module 51, a heating control module 52 that is configured to control the operation of the heating unit 20, and a front light control module 53 that is configured to control the operation of the front light unit 120. Each of the display module 51, the heating control module 52, and the front light control module 53 may be a hardware such as a circuit or may be configured to perform operations in response to the execution of a software such as a program stored in the memory by the processor or may be a combination thereof.

### Heating mode 1

The heating control module 52 is configured to output a driving signal to the heating unit 20 and switch the infrared LEDs (heating) between ON and OFF. The heating control module 52 obtains a detection signal from the temperature sensor 25. If the detected temperature is a first threshold value or lower, the heating control module 52 operates (turns on) the infrared LEDs. If the detected temperature is a second threshold value or higher, the heating control module 52 stops the operation (turns off) the infrared LEDs. The first threshold value and the second threshold value are determined according to the configuration of the electronic paper unit 10. The first threshold value is from 0°C to 10°C and the second threshold value is from 15°C to 25°C, for instance.

### Heating mode 2

If the frequency of switching a display image is low, the electronic paper unit 10 need not be always maintained at an appropriate temperature by the heating unit 20. Therefore, the heating control module 52 obtains a detection signal from the temperature sensor 25 a predetermined time prior to the display switching timing of the electronic paper unit 10. If the detected temperature is the first threshold value or lower, the heating control module 52 operates (turns on) the infrared LEDs. The heating control module 52 is configured to stop the operation of (turn off) the infrared LEDs at the timing of finishing the display switching of the electronic paper unit 10. The heating control module 52 obtains a detection signal from the temperature sensor 25 a predetermined time prior to the display switching timing of the electronic paper unit 10 and if the detected temperature is the second threshold value or higher, the heating control module 52 may be configured to stop the operation (turns off) the infrared LEDs. The first threshold value and the second threshold value may be same as the above-described values.

### Lighting mode 1

The front light control module 53 is configured to output a driving signal to the front light unit 120 and switch the white light sources 122 (lighting) between ON and OFF. The front light control module 53 obtains a detection signal from the illuminance sensor. If the detected illuminance is a predetermined threshold value or lower, the front light control module 53 operates (turns on) the white light sources 122. The front light control module 53 obtains a detection signal from the illuminance sensor and if the detected illuminance is a predetermined threshold value or higher, the front light control module 53 stops the operation (turns off) the white light sources 122. The threshold values are determined such that the illuminance is appropriate for human beings to see images and characters displayed on the electronic paper unit 10.

### Lighting mode 2

The front light control module 53 may be configured to operate (turn on) the white light sources 122 at a first time and to stop the operation of (turn off) the white light sources 122 at a second time. The first time and the second time may be determined as appropriate according to the way of using the display device 201. For instance, the first time and the second time may be the business start time and the closing time or the time when visibility with natural light is lowered such as the late evening and the recovery time of the visibility with natural light.

### Lighting mode 3

The front light control module 53 may be configured to stop the operation of (turn off) the white light sources 122 at the display switching timing of the electronic paper unit 10 even with the white light sources 122 being operated (on). For instance, the front light control module 53 may be configured not to turn on the white light sources 122 when the heating unit 20 is being operated (on) and configured to turn on the white light sources 122 when the heating unit 20 is turned off.

The display device 201 may further include a switching device as a separate component from the main body of the display device 201 for manually switching the operation of the heating unit 20 and the front light unit 120. The switching device is electrically connected to the main body (the control device 50) of the display device 201 with a wire or wireless. The switching device may include a first switch for switching the heating unit 20 between ON and OFF and a second switch for switching the front light unit 120 between ON and OFF.

A conventional electronic paper display device does not include a backlight unit and therefore, in a dark environment with little light to see an image or characters or a completely dark environment, visibility is lowered. The electronic paper display device 201 having the above configuration includes the white light sources 122 emitting white light and the light guide plate 124 (one example of the light guide layer). The light guide plate 124 is configured to guide white light emitted by the white light sources 122 to the display surface of the electronic paper unit 10. With such a configuration, even in a dark environment with less external light, visibility of the display of the display device 201 can be obtained.

The electronic paper display device 201 further includes the infrared light source as the heating unit 20 that is disposed on the display surface side of the electronic paper unit 10, the white light sources 122 disposed farther from the display surface of the electronic paper unit 10 than the infrared light sources are, the first cover layer including the infrared reflection film 130 that covers the display surface of the electronic paper unit 10 and reflects the infrared rays emitted by the infrared light sources, and the second cover layer including the light guide plate 124 (the light guide layer) that is disposed farther from the display surface than the first cover layer is and covers the display surface and in which white light emitted by the white light sources 122 travels. With such a configuration, a space (an air layer) is between the light guide plate 124 and the electronic paper unit 10 and particularly, a space (the air layer) is between the infrared reflection film 130 and the electronic paper unit 10. The white light that exits the front light unit 120 (namely, the white light sources 122 and the light guide plate 124) toward the back surface side (toward the electronic paper unit 10) passes through the infrared reflection film 130 and reaches the surface of the electronic paper unit 10. The light reflecting off the surface of the electronic paper unit 10 passes through the infrared reflection film 130 toward the front surface side. On the other hand, when the infrared rays from the heating unit 20 enter the infrared reflection film 130, the infrared rays are reflected by the infrared reflection film 130 toward the back surface side (toward the electronic paper unit 10). Accordingly, the space is heated with the infrared rays from the heating unit 20. The electronic paper unit 10 can be heated more uniformly with the convection of the heated air in the space. With the infrared reflection film 130, the infrared rays from the heating unit 20 are less likely to spread to the front light unit 120. Accordingly, the electronic paper unit 10 can be heated with higher efficiency.

The electronic paper display device 201 is configured to control driving of the heating unit 20. For instance, the display device 201 includes the heating control module 52 (one example of the control section) that controls driving of the heating unit 20, and the temperature sensor 25. The heating control module 52 is configured to drive the heating unit 20 when the environment temperature detected by the temperature sensor 25 is the first threshold value or lower and to stop driving of the heating unit 20 when the environment temperature detected by the temperature sensor 25 is the second threshold value or higher. The second threshold value is higher than the first threshold value. For instance, with this configuration being used in the mode in which display images are switched frequently, the electronic paper unit 10 can be always maintained within the temperature range that is appropriate for switching the display. Furthermore, in the mode in which the frequency of switching a display image is low and the mode in which the display image switching timing is previously specified, the display device 201 is configured to be maintained in the appropriate temperature range at the display image switching timing. Accordingly, display quality at the display image switching timing can be improved with reducing power consumption.

The electronic paper display device 201 is configured to control driving of the front light unit 120. For instance, the display device 201 is configured to automatically turn on and off the front light unit 120 according to the illuminance of the environment. Accordingly, good visibility of the display device 201 can be automatically and always maintained. The display device 201 is configured to control driving of the front light unit 120 in a predetermined time period or a timing when the heating unit 20 is not operated.

Accordingly, good visibility can be automatically maintained at a necessary timing. Good visibility can be maintained with reducing power consumption.

### Third Embodiment

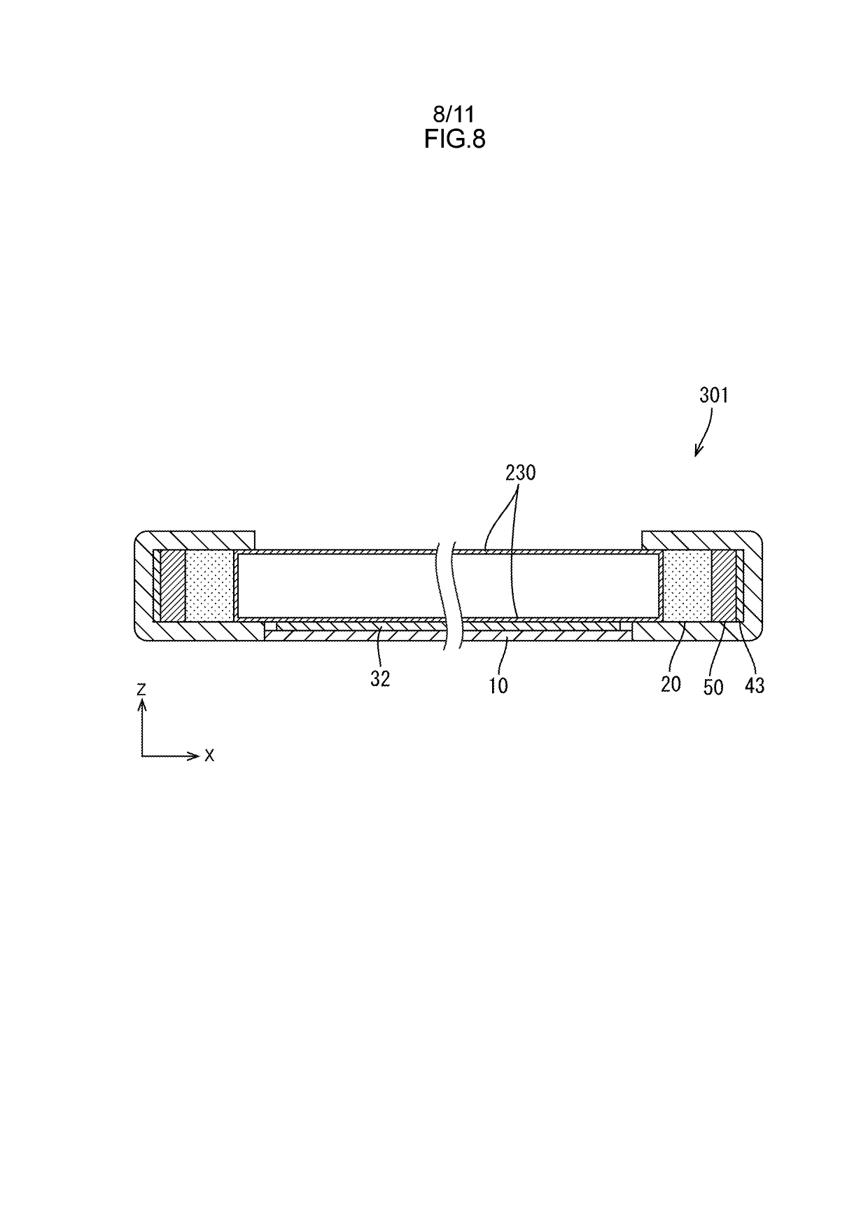

An electronic paper display device 301 of a third embodiment will be described. FIG. 8 is a cross-sectional view schematically illustrating a configuration of the electronic paper display device 301 of the third embodiment. The display device 301 of the third embodiment includes an infrared reflection film 230 (one example of the infrared reflection layer) as the cover layer instead of the light guide plate 30 of the first embodiment. Other configurations of the third embodiment may be similar to those of the first embodiment and the second embodiment and configurations, operations, and effects similar to those of the first embodiment and the second embodiment may not be described.

The infrared reflection film 230 is similar to the infrared reflection film 130 of the second embodiment. The infrared reflection film 230 is disposed away from the display surface of the electronic paper unit 10 and covers the electronic paper unit 10. For instance, as illustrated in FIG. 8, the infrared reflection film 230 is disposed to surround a space defined by the frame portion 40 above the electronic paper unit 10. More specifically, the infrared reflection film 230 is disposed to cover the inner space defined by the frame portion 40 from an upper side (an upper surface) and two sides extending in the Y-axis direction. The infrared reflection film 230 is fixed to the electronic paper unit 10 with the OCA 32 that is disposed on the non-display area A2 of the electronic paper unit 10. The infrared reflection film 230 is fixed to the electronic paper unit 10 on a lower side (a lower surface) of the inner space.

The short-side dimension of the infrared reflection film 230 substantially corresponds to a distance from the heating unit 20 disposed at one end with respect to the X-axis direction to the heating unit 20 disposed at the other end. The long-side dimension of the infrared reflection film 230 substantially corresponds to a total dimension of an inner dimension of the frame portion 40 measured in the Y-axis direction, an inner dimension measured in the Z-axis direction, and a margin for being fixed to the electronic paper unit 10 at two Y-axis end portions in the non-display area A2. The infrared reflection film 230 may be fixed to the opening edge portion of the display surface side frame portion 41 of the frame portion 40 with a fixing member 43 (for instance, a double-sided tape).

According to the electronic paper display device 301 having the above configuration, the infrared rays emitted by the heating unit 20 are reflected by the infrared reflection film 230 and the display surface of the electronic paper unit 10 is effectively supplied with the reflected infrared rays. The infrared rays emitted by the heating unit 20 stay in the space surrounded by the infrared reflection film 230. Accordingly, the electronic paper unit 10 is effectively heated.

An air layer (a space) is created between the electronic paper unit 10 and the infrared reflection film 230 and the air layer is isolated from the external air. The infrared rays emitted by the heating unit 20 is enclosed in the inner space defined by the frame portion 40 and the inner space is heated to an appropriate temperature with the infrared rays. The air convection is likely to occur in the inner space and the electronic paper unit 10 is heated uniformly with the air convection and heat transfer. Accordingly, the electronic paper unit 10 is heated with suppressing unevenness of heating.

### Fourth Embodiment

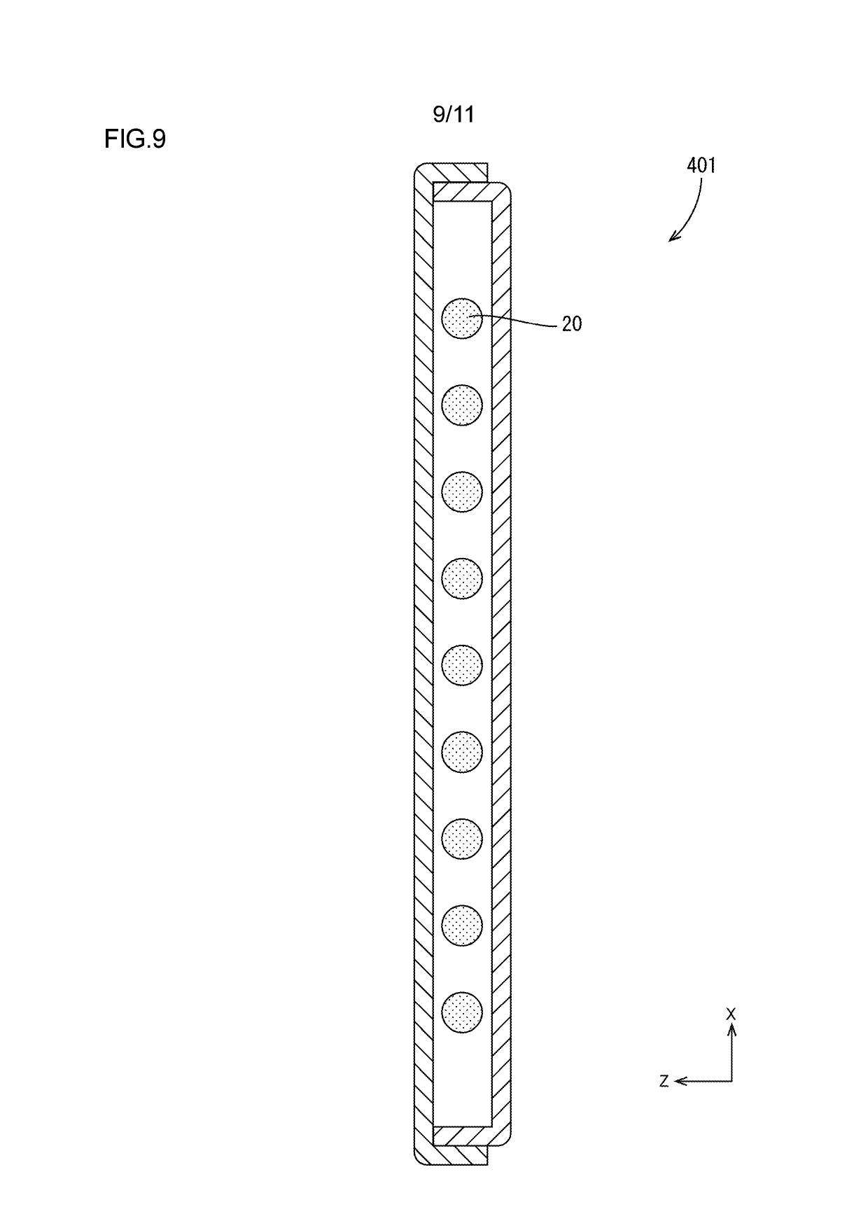

An electronic paper display device 401 of a fourth embodiment will be described. FIG. 9 is a cross-sectional view schematically illustrating a configuration of the heating unit 20 of the electronic paper display device 401 of the fourth embodiment. The heating unit 20 of the first embodiment is disposed along the long side of the electronic paper unit 10 and outside the display area A1. On the other hand, in the display device 401 of the fourth embodiment, the heating unit 20 is disposed along the short-side of the electronic paper unit 10 and outside the display area A1. Other configurations of the fourth embodiment may be similar to those of the first to the third embodiments. Configurations, operations, and effects similar to those of the first to third embodiments may not be described.

According to the size of the electronic paper unit 10 and configurations of the infrared light sources (such as output and directivity angle), the long-side dimension may be short and with the heating unit 20 being disposed along the short-side direction (at two ends in the Y-axis direction), the infrared rays can be sufficiently supplied to a middle portion of the electronic paper unit 10. Therefore, the number of the infrared LEDS of the heating unit 20 can be reduced with uniformly heating the electronic paper unit 10 including the middle portion thereof.

### Fifth Embodiment

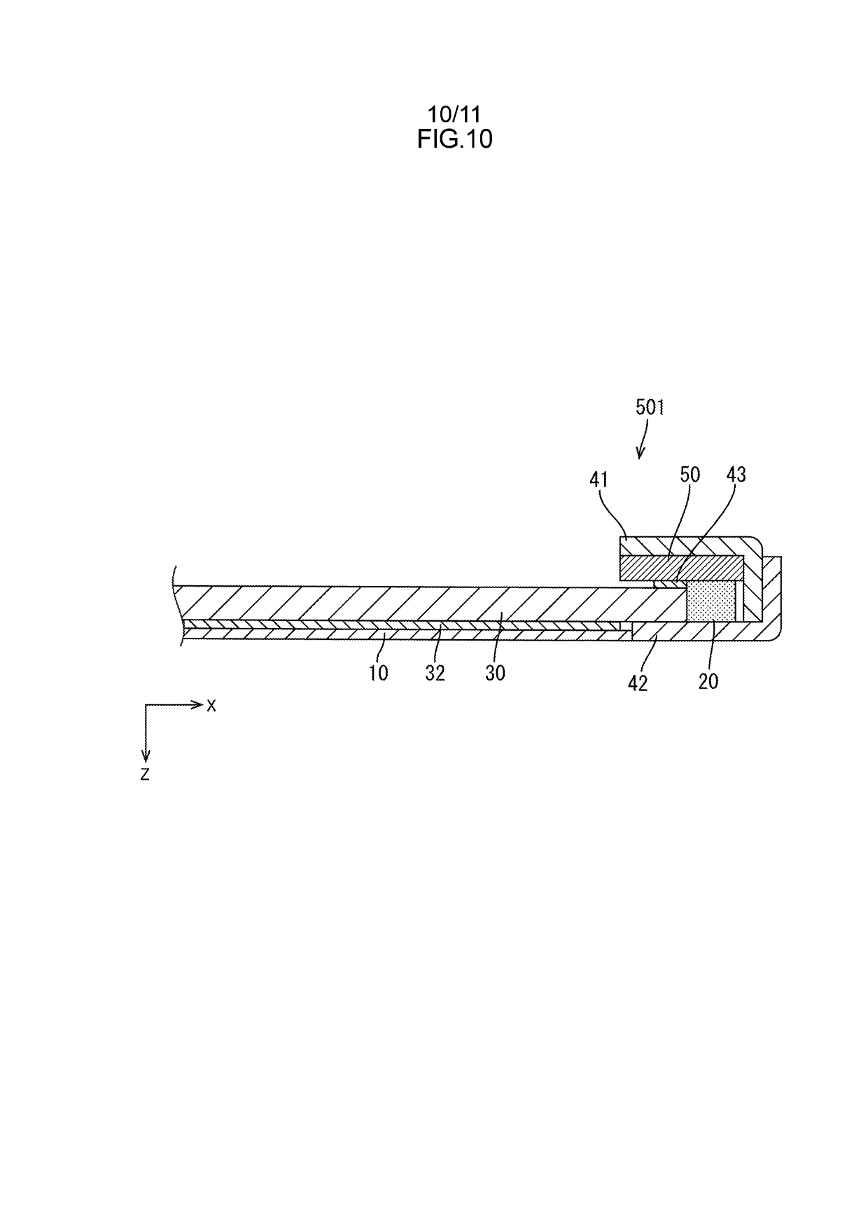

An electronic paper display device 501 of a fifth embodiment will be described. FIG. 10 is a cross-sectional view schematically illustrating a configuration of the electronic paper display device 501 of the fifth embodiment. In the display device 501 of the fifth embodiment, the method of fixing the control device 50 and the light guide plate 30 to the frame portion 40 differs from that of the first embodiment. Other configurations of the fifth embodiment may be similar to those of the first to fourth embodiments. Configurations, operations, and effects similar to those of the first to fourth embodiments may not be described.

In the display device 501 of the fifth embodiment, the base member where the control device 50 is mounted is fixed to a surface of the upper surface portion of the display surface side frame portion 41 of the frame portion 40 facing downward with a fixing member (such as a double-sided tape). The infrared LEDs are mounted on the base member where the control device 50 is mounted. The infrared LEDs emits infrared rays in the X-axis direction (parallel to the base member). The light guide plate 30 is fixed with the fixing member 43 (such as a double-sided tape) such that a lower surface of the light guide plate 30 is on a same surface plane as the lower surface of the heating unit 20 (lower surfaces of the infrared LEDs). The thickness of the light guide plate 30 may be adjusted such that a center of the edge surface with respect to the thickness direction corresponds to the light emitting portion of the infrared LED. With such a configuration, fitting properties of the components are improved and products of stably high quality can be produced. With the infrared rays emitted by the heating unit 20 travelling within the light guide plate 30, heat can be transferred to the electronic paper unit 10 via the surfaces of the light guide plate 30 and the electronic paper unit 10. According to this embodiment, the thickness and the weight of the display device can be reduced due to the reduction of the number of components although the heat efficiency is lowered compared to a configuration including the infrared reflection film. Further, the thickness of the electronic paper display device 501 can be relatively reduced.

The technology described herein is not limited to the embodiments described above and illustrated by the drawings. The above embodiments are described in detail for easy understanding of the present technology and the present technology does not necessarily include all the configurations of the above description. A portion of the configuration of one embodiment may be replaced with a configuration of another embodiment. The configuration of one embodiment may additionally include the configuration of another embodiment. A portion of the configuration of each embodiment may be deleted or replaced with other configuration or additionally include other configuration.

1. An electronic paper display device comprising:
an electronic paper unit configured to electrically rewrite a display image and keep the display image without supply of power; and
a heating unit disposed in a peripheral edge portion of the electronic paper unit and heating the electronic paper unit.

2. The electronic paper display device according to claim 1, wherein heating unit is disposed outside a display area of the electronic paper unit where the display image is displayed.

3. The electronic paper display device according to claim 1, further comprising a support frame that supports the heating unit with respect to the electronic paper unit, the support frame including at least one of heat insulation material or heat shielding material.

4. The electronic paper display device according to claim 1, further comprising a cover layer that covers a display surface of the electronic paper unit, wherein
the heating unit is configured to heat the electronic paper unit via the cover layer.

5. The electronic paper display device according to claim 1, further comprising:
a control section configured to control driving of the heating unit; and
a temperature sensor, wherein
the control section is configured to
drive the heating unit if an environment temperature detected by the temperature sensor is a first threshold value or lower, and
stop the driving of the heating unit if the environment temperature detected by the temperature sensor is a second threshold value or higher, and
the second threshold value is higher than the first threshold value.

6. The electronic paper display device according to claim 1, wherein the heating unit includes an infrared light source that emits infrared rays.

7. The electronic paper display device according to claim 6, wherein the infrared light source includes an infrared light emitting diode.

8. The electronic paper display device according to claim 6, further comprising a cover layer that covers a display surface of the electronic paper unit, the cover layer including an infrared reflection layer that reflects the infrared rays and being disposed away from the display surface of the electronic paper unit via the heating unit.

9. The electronic paper display device according to claim 4, wherein the cover layer includes a light guide layer in which at least one of white light or the infrared rays travels.

10. The electronic paper display device according to claim 9, further comprising a white light source that emits the white light, wherein
the light guide layer is configured such that the white light emitted by the white light source travels in light guide layer to the display surface of the electronic paper unit.

11. The electronic paper display device according to claim 1, further comprising:
an infrared light source disposed on a display surface side of the electronic paper unit as the heating unit;
a white light source disposed farther from a display surface of the electronic paper unit than the infrared light source is;
a first cover layer that covers the display surface and includes an infrared reflection layer reflecting infrared rays emitted by the infrared light source; and
a second cover layer that is disposed farther from the display surface than the first cover layer is and covers the display surface and includes a light guide layer in which white light emitted by the white light source travels.

12. The electronic paper display device according to claim 1, wherein the electronic paper unit includes
a transparent electrode substrate including a transparent electrode,
a back electrode substrate including back electrodes corresponding to pixels, the back electrodes including thin film transistors, and
a display medium layer disposed between the transparent electrode substrate and the back electrode substrate and including a display medium.

13. The electronic paper display device according to claim 8, wherein the cover layer includes a light guide layer in which at least one of white light or the infrared rays travels.
